(19) United States
(12) Patent Application Publication
(10) Pub. No.: US 2007/0077390 A1
(43) Pub. Date: Apr. 5, 2007

(54) Linking tape structure

(75) Inventor: Shih-Sheng Yang, Wu Ku Industrial Zone (TW)

Correspondence Address: Troxell Law Office Pllc, Suite 1404, 5205 Leesburg Pike, Falls Church, VA, 22041, US

(73) Assignee: Universal Trim Supply Co., Ltd.

(21) Appl. No.: 11/242,882

(22) Filed: Oct. 5, 2005

(51) Int. Cl. B32B 3/06

(52) U.S. Cl. 428/99; 428/100

(57) ABSTRACT

A linking tape structure includes primarily a pair of male and female linking tapes which are formed integrally and mutually corresponding to each other. Pluralities of pillars are uniformly distributed on a board of the male linking tape and a blunt head with a larger diameter is located on an end surface of the pillar, so as to form a hook-shape unit. The female linking tape is provided with the same structure as that of the male linking tape, and is installed correspondingly to the male linking tape. When the male and female linking tapes are bonded face to face, the hook-shape units of the boards of male and female linking tapes will be latched in a mutually interleaved manner, thereby constituting a brand new linking tape structure.

### BACKGROUND OF THE INVENTION

(a) Field of the Invention

The present invention relates to a linking tape structure design, and more particularly to a linking tape structure for reducing the noise generated upon tearing off the linking tapes, increasing the lifespan the linking tapes, and improving their texture and sense of beauty.

(b) Description of the Prior Art

A conventional linking tape structure includes a male linking tape and a female linking tape, wherein pluralities of felts which are protruded and have a hook in their tails are uniformly distributed on a surface of the male linking tape, thereby constructing a felt surface; threads which are curly wound are uniformly distributed on a surface of the female linking tape, thereby constructing a fluff surface. When the felt surface of the male linking tape and the fluff surface of the female linking tape are pasted together, the hook-shape felt surface will be hooked on the curly wound threads to be fixed together. Although the aforementioned conventional linking tape structure can be used to fix a bonded object which needs to be linked, an extremely loud noise will be generated upon tearing off the linking tapes, and a stinging surface will be formed on the hook-shape felt surface of the male linking tape. In addition, it is easy for the sting-shape hooks to scratch a high quality fabric or hook up a tag of knitted cloth, thereby causing damage to the fabric of clothes. On the other hand, it is easy to fracture the threads on the fluff surface due to a pulling of gravity force or other batts can be stuck on the felt surface of male linking tape after using the linking tapes for a while, thereby reducing their adhesive force. Accordingly, a conventional linking tape structure has a drawback in that it does not have a long lifetime of usage.

### SUMMARY OF THE INVENTION

The primary object of the present invention is to provide a linking tape structure having an elastic hook-shape unit which is formed integrally, such that a noisy sound will not be sent out upon tearing off after mutually attaching the linking tapes, thereby enabling a consumer to easily tear off the linking tapes without a limitation to a quite situation. Another object of the present invention is to provide a linking tape structure having a soft hook-shape unit, which will not damage a surface of fabric and batts are not easily to be attached on the surface of linking tapes, so as to achieve a fine texture and a sense of beauty, as well as to increase their adhesion effect.

Accordingly, the present invention is primarily composed of a pair of male and female linking tapes which are formed integrally and mutually corresponding, wherein pluralities of pillars are uniformly distributed on a board of the male and female linking tapes, respectively. An end surface of the pillar is provided with a blunt head having a larger diameter, so as to form a hook-shape unit. The female and male linking tapes are bonded face to face, and the hook-shape units on the boards of two tapes are uniformly distributed in a mutually interleaved manner, such that the elastic hook-shape units on the surfaces of male and female linking tapes can be mutually latched, thereby forming a brand new linking tape structure.

To enable a further understanding of the said objectives and the technological methods of the invention herein, the brief description of the drawings below is followed by the detailed description of the preferred embodiments.

### BRIEF DESCRIPTION OF THE DRAWINGS

FIG. 1 shows a perspective view of the present invention.

FIG. 2 shows a perspective view of the present invention after being adhered.

FIG. 3 shows a cut-away view of the present invention after being adhered.

FIG. 4 shows a schematic view of installing a hook-shape unit of the present invention.

FIG. 5 shows another schematic view of installing a hook-shape unit of the present invention.

FIG. 6 shows a cut-away view of a hook-shape unit of the present invention.

FIG. 7 shows a cut-away view of another implementation of a hook-shape unit of the present invention.

FIG. 8 shows a cut-away view of still another implementation of a hook-shape unit of the present invention.

FIG. 9 shows a schematic view of a series of square head end of a hook-shape unit of the present invention.

FIG. 10 shows a schematic view of a series of triangular head end of a hook-shape unit of the present invention.

FIG. 11 shows a schematic view of a series of circular head end of a hook-shape unit of the present invention.

FIG. 12 shows a schematic view of a series of rectangular head end of a hook-shape unit of the present invention.

### DETAILED DESCRIPTION OF THE PREFERRED EMBODIMENTS

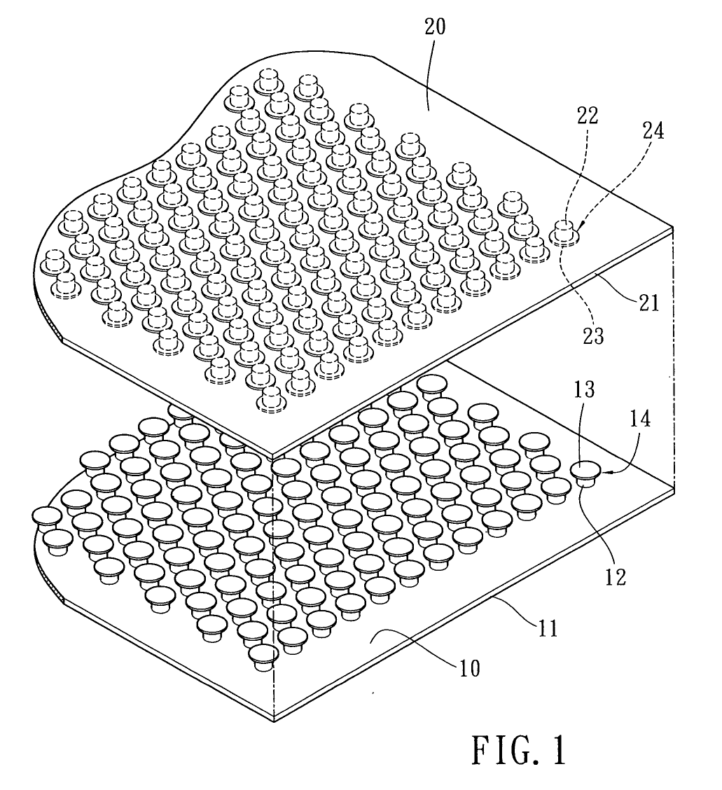

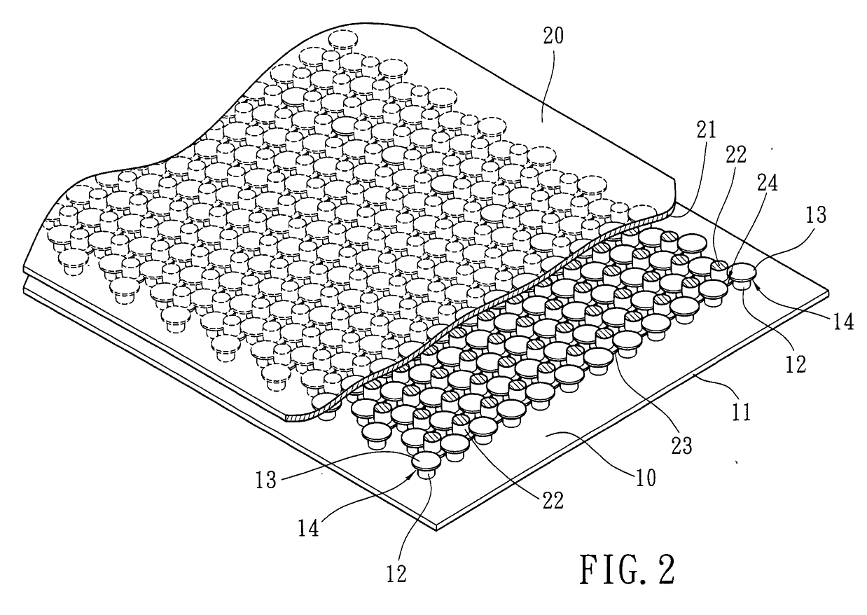

Referring to FIG. 1 to FIG. 3, the present invention comprises primarily a pair of male linking tape 10 and female linking tape 20 which are made from an elastic material, formed integrally, and mutually corresponding. Pluralities of cylinders 12 are uniformly distributed on a board of the male linking tape 10, with a cone 13 in a larger diameter located on an end surface of the cylinder 12, so as to form a hook-shape unit 14.

The female linking tape 20 has a same structure as that of the male linking tape 10, so that they can be bonded face to face upon assembling the male linking tape 10 and the female linking tape 20, and the hook-shape unit 14 of the male linking tape 10 can be latched with a hook-shape unit 24 of the female linking tape 20 in a mutually interleaved manner. Pluralities of cylinders 22 are also uniformly distributed on a board 21 of the female linking tape 20, and a cone 23 in a larger diameter is located on an end surface of the cylinder 22, so as to constitute the hook-shape unit 24 by the single cylinder 22 and the cone 23.

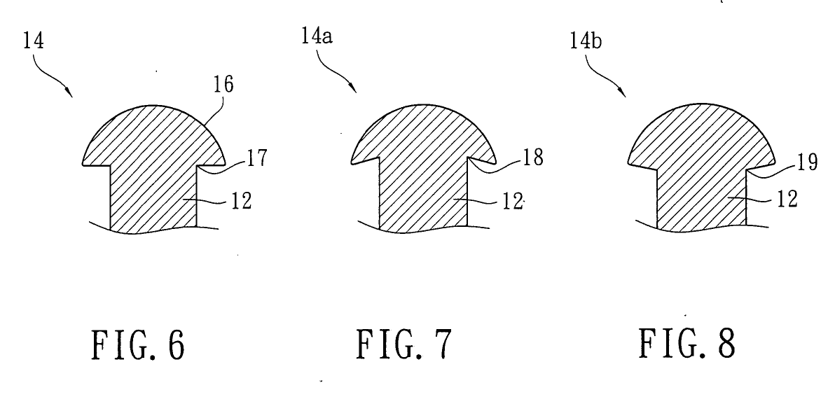

As shown in FIGS. 1-3, a top end of the cone 13 is roughly in a sharp shape, such that a periphery of central cusp is designed as a slope. Accordingly, when latching the two cones 13, 23, they can be glided and assembled with the slope. If the design is changed such that the cone 13 is in an umbrella shape 16 (as shown in FIG. 6) having a larger diameter of a part thereof than that of the cylinder 12, then a hook-shape unit 14 can still be formed.

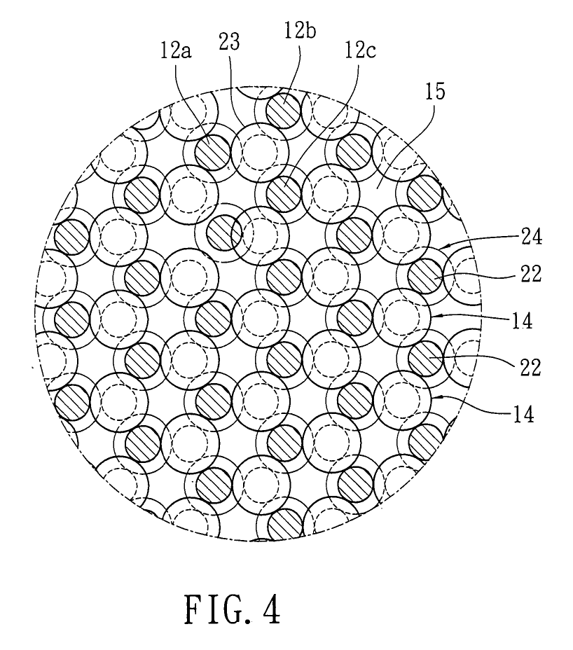

Referring to FIG. 4, cylinders 12a, 12b, 12c on the male linking tape 10 are separated from one another to form a specific space 15 which must be larger than the diameter of the cone 23, so as to contain the cone 23 on the female linking tape 20 upon assembling. Correspondingly, a space formed by a separation among cylinders 22a, 22b, 22c located on the female linking tape 20 should also be able to contain the cone 13 on the male linking tape 10 upon assembling. Accordingly, when the cone 13 is pushed and latched to the corresponding cone 23 by a force, they are elastically deformed, thereby maintaining an effect of positioning after being latched in.

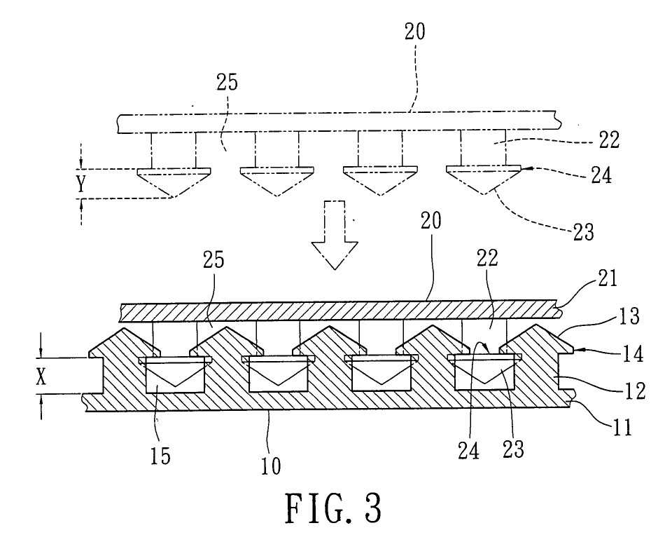

Referring to FIG. 3, a height X from a bottom end of the hook-shape unit 14 on the male linking tape 10 to the board 11 must be greater than or equal to a total thickness Y of the corresponding cone 23 on the hook-shape unit 24. Therefore, when mutually latching the male linking tape 10 and the female linking tape 20, the cone 13 on the board can be contained in the corresponding space 15, and in the mean time, the cone 23 can also be contained in the space 15. Accordingly, the male and female linking tapes 10, 20 can be mutually bonded, and the hook-shape units 14, 24 on the surfaces thereof are tightly latched.

Referring to FIG. 4, it shows a layout of installing the hook-shape units 14, 24 on the boards of male linking tape 10 and female linking tape 20, wherein three hook-shape units 14 are corresponding to one hook-shape unit 24; all of them are mutually interleaved and uniformly distributed.

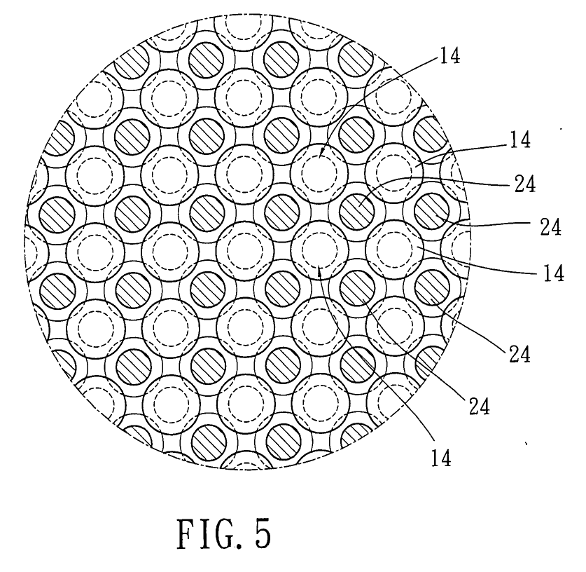

Referring to FIG. 5, when four hook-shape units 14 are corresponding to one hook-shape unit 24, all of them can also be mutually interleaved and uniformly distributed. Accordingly, when six or eight hook-shape units 14 are corresponding to one hook-shape unit 24, they can definitely be mutually interleaved and uniformly distributed; they all can achieve a same effect of bonding the male and female linking tapes.

As the linking tapes of the present invention are made from a proper soft material, the cones 13, 23 formed are provided with elasticity themselves. Therefore, when the hook-shape units 14, 24 on the male linking tape 10 and the female linking tape 20 are mutually latched, it will be performed silently. Similarly, upon tearing off both tapes, they will be naturally separated apart without making a sound, Which forms a linking tape product which is silent in tearing off, thereby being suitable for using in a public place without interfering with other people.

A size of the hook-shape units 14, 24 of the present invention is unlimited, which means that when the hook-shape units are made to be larger, they can be applied in bonding a specific object such as a belt of a saddler, or a band for bundling goods. On the other hand, when the hook-shape units are made to be smaller, they can be applied on delicate clothes, gloves, leather backpacks, and shoes, to serve as a tightening of opening. In addition, the pillars of the hook-shape units 14, 24 of the present invention can be made into a cylinder, a square pillar, a triangular pillar, or other pillar with an irregular shape, as long as the outline of pillar is smaller than that of the blunt head.

Referring to FIG. 6, it shows the hook-shape unit 14 as an example of the hook-shape units 14, 24 on the male linking tape 10 and the female linking tape 20. A right angle 17 can be formed at an interface between a top end of the cylinder 12 and a bottom end of the cone 13, which will generate a moderate adhesive force upon mutually latching the hook-shape units 14, 24.

Referring to FIG. 7, an acute angle 18 is formed at an interface between a top end of the cylinder 12 and a bottom end of the cone 13, which will generate a strongest adhesive force upon mutually latching the hook-shape units 14, 24.

Referring to FIG. 8, an obtuse angle 19 is formed at an interface between a top end of the cylinder 12 and a bottom end of the cone 13, which will generate a weakest adhesive force upon mutually latching the hook-shape units 14, 24. Accordingly, the design can be adapted depending on a situation in which the linking tapes are applied.

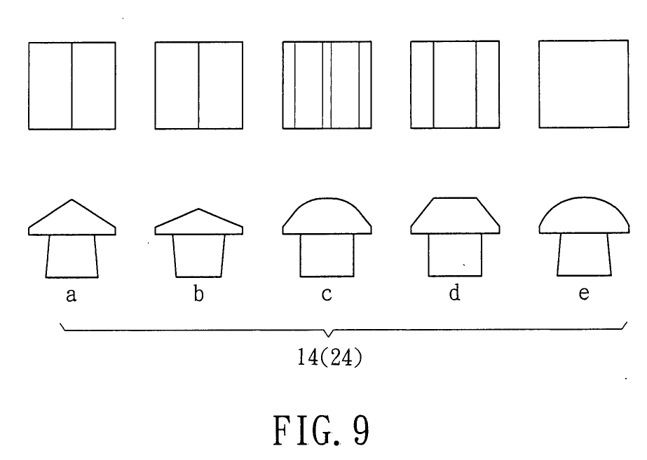

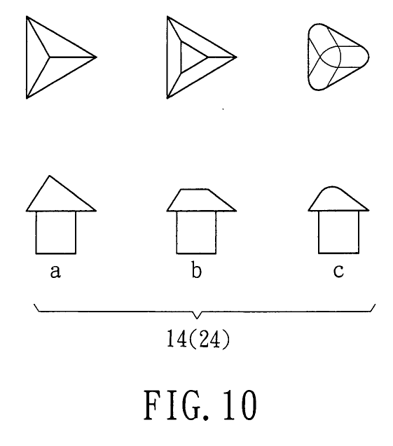

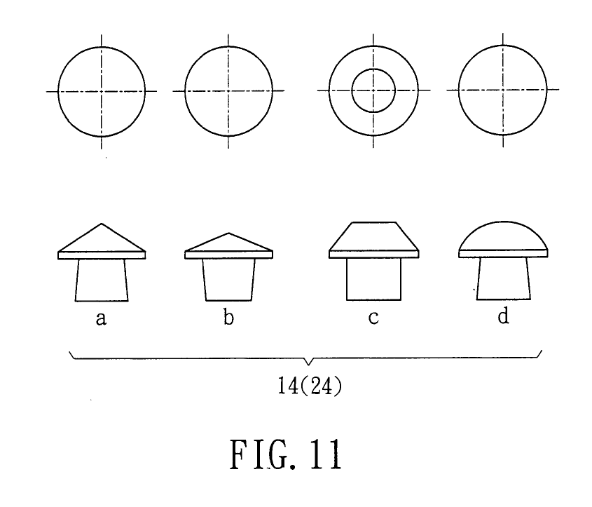

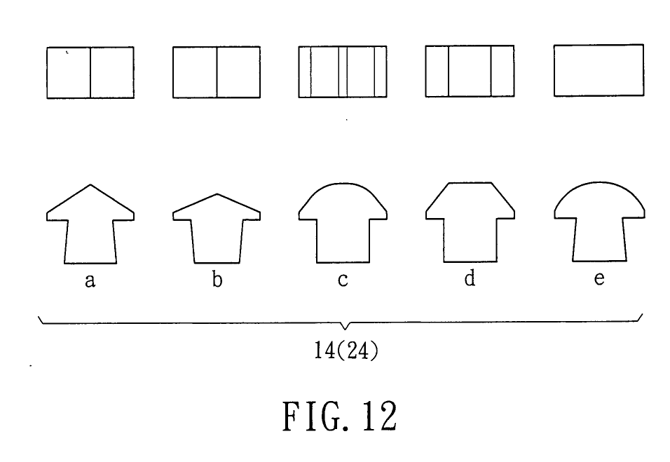

A blunt head is located on the pillar of the hook-shape units 14 (or 24) of the present invention. The blunt head can be designed as a series of square head ends a˜e (as shown in FIG. 9), a series of triangular head ends a˜c (as shown in FIG. 10), a series of circular head ends a˜d (as shown in FIG. 11), or a series of rectangular head ends a˜e (as shown in FIG. 12).

Accordingly, the linking tape structure of the present invention consists of a structure having the elastic hook-shape units which are formed integrally and mutually latched, so that a noisy sound will not be created upon tearing off, and a bonded object such as a surface of fabric of clothes will not be damaged, which is capable of improving texture and a sense of beauty, thereby having a value of industrial utilization.

It is of course to be understood that the embodiments described herein is merely illustrative of the principles of the invention and that a wide variety of modifications thereto may be effected by persons skilled in the art without departing from the spirit and scope of the invention as set forth in the following claims.

What is claimed is:

1. A linking tape structure, which is made from an elastic material, comprising a pair of male linking tape and female linking tape which are formed integrally and mutually corresponding to each other; pluralities of pillars uniformly distributed on a board of the male linking tape With an larger blunt head on a top end of the pillar, so as to form a hook-shape unit; the female linking tape is provided with the same structure as that of the male linking tape, and bonded face to face with the male linking tape, with the hook-shape units on a board of the female linking tape mutually interleaved and uniformly distributed with the hook-shape units of the male linking tape.

2. The linking tape structure according to claim 1, wherein a height from a bottom board to the blunt head of the pillar is greater than a total thickness of the blunt head.

3. The linking tape structure according to claim 1, wherein a height from a bottom board to the blunt head of the pillar is equal to a total thickness of the blunt head.

4. The linking tape structure according to claim 1, wherein a space formed by a separation among the pillars installed on the male linking tape must be greater than the area of blunt head on the female linking tape.

5. The linking tape structure according to claim 1, Wherein a layout of the hook-shape units of the male and female linking tapes is three corresponding to one, while all the relative hook-shape units are mutually interleaved and uniformly distributed.

6. The linking tape structure according to claim 1, wherein a layout of the hook-shape units of the male and female linking tapes is four corresponding to one, while all the relative hook-shape unitsare mutually interleaved and uniformly distributed.

7. The linking tape structure according to claim 1, wherein a layout of the hook-shape units of the male and female linking tapes is six corresponding to one, while all the relative hook-shape units are mutually interleaved and uniformly distributed.

8. The linking tape structure according to claim 1, wherein a layout of the hook-shape units of the male and female linking tapes is eight corresponding to one, while all the relative hook-shape units are mutually interleaved and uniformly distributed.

9. The linking tape structure according to claim 1, wherein the blunt head on the male linking tape or the female linking tape is in the form of a cone.

10. The linking tape structure according to claim 1, wherein a right angle can be formed at an interface between a top end of the pillar and a bottom end of the blunt head.

11. The linking tape structure according to claim 1, wherein an acute angle can be formed at an interface between a top end of the pillar and a bottom end of the blunt head.

12. The linking tape structure according to claim 1, wherein an obtuse angle can be formed at an interface between a top end of the pillar and a bottom end of the blunt head.

13. The linking tape structure according to claim 1, wherein the pillar can be a cylinder.

14. The linking tape structure according to claim 1, wherein the pillar can be a square pillar.

15. The linking tape structure according to claim 1, wherein the pillar can be a triangular pillar.

16. The linking tape structure according to claim 1, wherein the blunt head can be provided with a square head end.

17. The linking tape structure according to claim 1, Wherein the blunt head can be provided with a circular head end.

18. The linking tape structure according to claim 1, wherein the blunt head can be provided with a triangular head end.

19. The linking tape structure according to claim 1, wherein the blunt head can be provided with a rectangular head end.
